(19) United States
(12) Patent Application Publication
(10) Pub. No.: US 2011/0216020 A1
(43) Pub. Date: Sep. 8, 2011

(54) LARGE-SIZE TOUCH SCREEN

(75) Inventors: Jong Young Lee, Gyunggi-do (KR); Yong Soo Oh, Gyunggi-do (KR); Ho Joon Park, Seoul (KR); Sang Hwa Kim, Gyunggi-do (KR)

(73) Assignee: SAMSUNG ELECTRO-MECHANICS CO., LTD., Gyunggi-do (KR)

(21) Appl. No.: 12/901,142

(22) Filed: Oct. 8, 2010

(30) Foreign Application Priority Data
Mar. 2, 2010 (KR) 1020100018601

(51) Int. Cl. G06F 3/041

(52) U.S. Cl. 345/173

(57) ABSTRACT

Disclosed herein is a touch screen, including: a transparent film having a thickness of 188˜2000 μm; and a transparent electrode layer formed on one side or both sides of the transparent film, wherein one side or both sides of the transparent film is ultraviolet-treated, high-frequency-treated or primer-treated. The touch screen is advantageous in that a hard coating layer included in conventional touch screens was removed thereby improving its transmittance, and in that the number of total structural layers was decreased to strengthen its price competitiveness. Further, the touch screen is advantageous in that a hard coating layer was removed which reduces the manufacturing process, and in that the thickness of a base film was increased allowing touch screens having a size of 22 inches or more to be manufactured.

### CROSS REFERENCE TO RELATED APPLICATION

This application claims the benefit of Korean Patent Application No. 10-2010-0018601, filed Mar. 2, 2010, entitled “Touch screen for vast vision”, which is hereby incorporated by reference in its entirety into this application.

### BACKGROUND OF THE INVENTION

1. Technical Field

The present invention relates to a large-size touch screen.

2. Description of the Related Art

As various computers, electrical household appliances, and communication appliances are being digitalized and rapidly becoming highly-functionalized, it is keenly required to realize portable displays. In order to realize the portable displays, electrode materials for the portable displays must be transparent and have low resistance, must exhibit high flexibility so that the portable displays are mechanically stable, and must have a thermal expansion coefficient similar to that of a substrate not to overheat apparatuses and not to cause a short circuit or great changes in resistance even at high temperatures.

Currently, a touch screen including an indium tin oxide (ITO) film and a hard coating window is problematic in that many processes are required to form the functional layers, and the number of layers is increased, thus decreasing transmittance and productivity.

In the case of resistive touch screens, it is difficult to manufacture a resistive touch screen having a size of 22 inches or more because of an intermediate air gap.

In order to solve the above problem, it is proposed to develop a touch screen having a size of 22 inches or more, which is manufactured using a conductive material, and the transmittance of which is decreased due to the decrease in the number of layers.

In general touch screens, a hard coating layer is formed on a transparent film before transparent electrodes are formed on the transparent film. In this case, there is a problem in that the number of structural layers is inevitably increased, thus decreasing transmittance and increasing price. Further, as described above, many problems, such as an increase in manufacturing cost, a decrease in transmittance and the like, result from the formation of the hard coating layer. Further, in resistive touch screens, it was difficult to manufacture a large-size resistive touch screen having a size of 22 inches because of an intermediate air gap.

Therefore, there is a need for technology that manufactures a large-size resistive touch screen having a size of 22 inches or more without increasing the number of structural layers.

### SUMMARY OF THE INVENTION

Accordingly, the present invention has been made to solve the above-mentioned problems, and the present invention provides a large-size touch screen having a size of 22 inches or more.

An aspect of the present invention provides a touch screen, including: a transparent film having a thickness of 188˜2000 μm; and a transparent electrode layer formed on one side or both sides of the transparent film, wherein one side or both sides of the transparent film is ultraviolet-treated, high-frequency-treated or primer-treated.

Here, the transparent electrode layer may be formed by a printing process.

Further, the transparent electrode layer may be made of poly-3,4-ethylenedioxythiophene/polystyrenesulfonate (PEDOT/PSS).

Further, the transparent electrode layer may be made of a conductive polymer composition including a liquid crystal polymer and poly-3,4-ethylenedioxythiophene/polystyrenesulfonate (PEDOT/PSS).

Further, the transparent electrode layer may be formed of a conductive adhesive prepared by mixing a transparent adhesive with one or more selected from a conductive polymer (for example, poly-3,4-ethylenedioxythiophene/polystyrenesulfonate, manufactured by Bayer Corp. or AGFA Corp., or polyaniline), carbon nanotubes, carbon black, graphene, metal or silver nanowires, copper (Cu), indium tin oxide (ITO) and antimony tin oxide (ATO).

Further, the liquid crystal polymer may be an acrylic liquid crystal polymer.

Further, a conductive polymer film made of the conductive polymer composition may have a surface resistance of 10˜1000 Ω/□.

Further, the liquid crystal polymer may be 1,4-bis[3-(acryloyloxy)propyloxy]-2-methyl benzene.

Further, the transparent film may include one or more selected from a hard coating layer, an anti-fingerprint (AF) layer, an anti-glare (AG) layer and an anti-reflection (AR) layer formed on the outer surface thereof.

Further, the transparent film may be made of polyethylene terephthalate (PET), polyethylene naphthalate (PEN), polyether sulfone (PES), glass, reinforced glass, polycarbonate (PC), cycloolefin copolymer (COC), polymethylmethacrylate (PMMA), triacetylcellulose (TAC), K-resin-containing biaxially-oriented polystyrene (BOPS), or a mixture thereof.

Further, the transparent film may be any one selected from a polyethylene terephthalate (PET) film having a dielectric constant of 2.9˜3.5, a glass film having a dielectric constant of 7.5˜8.0, a silicon film having a dielectric constant of 2.5˜7.0, a urethane film having a dielectric constant of 6.5˜7.0, a polymethylmethacrylate (PMMA) film having a dielectric constant of 2.5˜4.5, and a polycarbonate (PC) film having a dielectric constant of 2.5˜3.5.

Further, the transparent film may further include a silver (Ag) electrode layer at an edge thereof.

Further, the silver (Ag) electrode layer may be formed by a printing process.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view showing a resistive touch screen according to the present invention; and

FIG. 2 is a schematic sectional view showing a capacitive touch screen according the present invention.

### DESCRIPTION OF THE PREFERRED EMBODIMENTS

The objects, features and advantages of the present invention will be more clearly understood from the following detailed description and preferred embodiments taken in conjunction with the accompanying drawings.

Further, in the description of the present invention, when it is determined that the detailed description of the related art would obscure the gist of the present invention, the description thereof will be omitted.

Hereinafter, a preferred embodiment of the present invention will be described in detail with reference to the attached drawings.

A touch screen according to an embodiment of the present invention includes: a transparent film having a thickness of 188˜2000 μm; and transparent electrode layers formed on one side or both sides of the transparent film, wherein one side or both sides of the transparent film is ultraviolet-treated, high-frequency-treated or primer-treated.

In general touch screens, since transparent electrodes are made of indium tin oxide (ITO), a transparent film can be warped or twisted when ITO is deposited on the transparent film and then a baking process is conducted. Therefore, in order to prevent the transparent film from being warped, hard coating layers must be formed on both sides of the transparent film. For this reason, the number of structural layers is increased, thus causing several problems, such as the decrease in transmittance, the increase in price, and the like. Therefore, due to the above problems and the flexibility of the transparent film, conventionally, it has been difficult to manufacture a large-size touch screen having a size of 20 inches or more.

However, as described above, since the touch screen of the present invention may include a transparent film having a thickness of 188˜2000 μm, it is possible to manufacture a large-size touch screen which cannot be accomplished by conventional technologies.

That is, since the transparent electrodes used in the present invention are made of a conductive polymer, heat or force is not excessively used at the time of forming the transparent electrodes, so that it is not required to form a hard coating layer for preventing the transparent film from being warped, thereby being advantageous in the manufacturing of a touch screen.

Further, the transparent electrodes may be formed by a printing process, such as a gravure printing process, a screen printing process, an offset printing process, an ink-jet printing process or the like. In this case, the transparent electrodes may be formed of a conductive adhesive which is prepared by mixing a transparent adhesive with one or more selected from a conductive polymer (for example, poly-3,4-ethylenedioxythiophene/polystyrenesulfonate, manufactured by Bayer Corp. or AGFA Corp., or polyaniline), carbon nanotubes, carbon black, graphene, metal or silver nanowires, copper (Cu), indium tin oxide (ITO) and antimony tin oxide (ATO), and which have a viscosity suitable for a specific printing process.

The transparent electrodes may be made of poly-3,4-ethylenedioxythiophene/polystyrenesulfonate (PEDOT/PSS), more preferably, a conductive polymer composition including a conductive polymer and a liquid crystal polymer because they must have low surface resistance.

The liquid crystal polymer is a compound exhibiting both crystal properties and polymer properties. Liquid crystal is an intermediate phase between the solid and liquid phases. Since liquid crystal, unlike solids, has an orientational order although it does not have a positional order, it exhibits intrinsic properties. Further, liquid crystal exhibits different properties from liquids which have no order.

As described above, since the liquid crystal polymer has intrinsic liquid crystal properties, it exerts an influence on the form and arrangement of the conductive polymer when it is mixed with the conductive polymer. Therefore, due to the high orientational order of the liquid crystal polymer, the orientation order of the conductive polymer is also increased, and simultaneously the conductivity of the film formed of this composition can be rapidly increased.

Generally, in order to improve the conductivity of the conductive polymer, a polar solvent, referred to as a secondary dopant, is used. However, even in this case, the conductive polymer has a surface resistance of 1000 Ω/□, which is a realizable limit value. Meanwhile, in order to ensure film characteristics, a binder is inevitably used as an additive. However, even when the binder is used, it is possible to prevent the deterioration of the film characteristic related to surface resistance.

However, as described above, when the liquid crystal polymer is added, it is possible to prevent the conductivity of the film from being deteriorated because the binder is not used or is minimally used.

As the liquid crystal polymer, liquid crystal monomers may be directly added or may be polymerized. The liquid crystal monomer may be an acrylic monomer. For example, 1,4-bis[3-(acryloyloxy)propyloxy]-2-methyl benzene (RM257 or RM82, manufactured by Merck & Co., Inc.) may be used as the liquid crystal monomer. The liquid crystal monomer may be independently used or may be used together with an isotropic monomer such as hexanediol diacrylate (HDDA), but the present invention is not limited thereto.

The conductive polymer used in the present invention may be poly-3,4-ethylenedioxythiophene/polystyrenesulfonate (PEDOT/PSS), but is not limited thereto.

The amount of the liquid crystal polymer may be 0.1˜20 parts by weight based on the weight of the conductive polymer. When the amount of the liquid crystal polymer is below 0.1 parts by weight, the effects of improving the conductivity and adhesivity due to the use of the liquid crystal polymer are slight. Further, when the amount of the liquid crystal polymer is above 20 parts by weight, the amount of the conductive polymer or solvent used relative to the liquid crystal polymer is relatively small, thus decreasing conductivity.

The conductive polymer composition including the conductive polymer and the liquid crystal polymer may be prepared by directly mixing its undiluted solution with the liquid crystal polymer, and may be used after being applied on a plastic substrate.

A conductive polymer film made of the conductive polymer composition may have a surface resistance of 10˜1000 Ω/□.

Further, the transparent electrode layers may be formed of a conductive adhesive which is prepared by mixing a transparent adhesive with one or more selected from a conductive polymer (for example, poly-3,4-ethylenedioxythiophene/polystyrenesulfonate, manufactured by Bayer Corp. or AGFA Corp., or polyaniline), carbon nanotubes, carbon black, graphene, metal or silver nanowires, copper (Cu), indium tin oxide (ITO) and antimony tin oxide (ATO), and which have a viscosity suitable for a specific printing process.

Examples of the binder for the conductive polymer film may include an acrylic binder, an epoxy binder, an ester binder, a urethane binder, an ether binder, a carboxylic binder, an amide binder, and the like. The binder may be selectively used depending on the kind of a substrate.

Further, the conductive polymer composition may further include a polar solvent as a secondary dopant in order to improve the conductivity of the conductive polymer film.

The polar solvent, as a secondary dopant, may be one or more selected from dimethylsulfoxide, N-methylpyrrolidone, N,N-dimethylformamide, and N-dimethylacetimide.

Further, the conductive polymer composition may further include a dispersion stabilizer. Ethyleneglycol, sorbitol or the like may be used as the dispersion stabilizer.

Moreover, the conductive polymer composition may further include a binder, a surfactant, an antifoamer, or the like.

Meanwhile, the transparent film may include one or more selected from a hard coating layer, an anti-fingerprint (AF) layer, an anti-glare (AG) layer and an anti-reflection (AR) layer formed on the outer surface thereof. The anti-fingerprint (AF) layer is designed to increase the wetness of the hard coating layer, so that, even when fingerprint components are adhered to the hard coating layer, they do not conspicuously appear on the hard coating layer because the wetness of the hard coating layer spreads. The anti-glare (AG) layer may be formed using a circular polarization principle, a pattern imprinting technology or the like, but the present invention is not limited thereto. The anti-reflection (AR) layer decreases the refractive index of the transparent film, so that the reflectance of the transparent film is decreased, thereby improving the transparency of the transparent film.

The transparent film may be made of polyethylene terephthalate (PET), polyethylene naphthalate (PEN), polyether sulfone (PES), glass, reinforced glass, polycarbonate (PC), cycloolefin copolymer (COC), polymethylmethacrylate (PMMA), triacetylcellulose (TAC), K-resin-containing biaxially-oriented polystyrene (BOPS), or a mixture thereof.

Further, in capacitive touch screens, the transparent film may be made of a material having a high dielectric constant. When the transparent film is made of the material having a dielectric material, its sensitivity is improved with an increase in the capacitance.

Therefore, the transparent film may be any one selected from a polyethylene terephthalate (PET) film having a dielectric constant of 2.9˜3.5, a glass film having a dielectric constant of 7.5˜8.0, a silicon film having a dielectric constant of 2.5˜7.0, a urethane film having a dielectric constant of 6.5˜7.0, a polymethylmethacrylate (PMMA) film having a dielectric constant of 2.5˜4.5, and a polycarbonate (PC) film having a dielectric constant of 2.5˜3.5.

Further, electrodes for supplying voltage to the transparent electrode may be printed at the edge of the transparent film by a silk screening process, a gravure printing process, an ink-jet printing process or the like. In this case, the electrodes for supplying voltage may be made of silver paste or organic silver having high electroconductivity, but the present invention is not limited thereto. In addition, as the electrodes for supplying voltage, conductive polymer materials, carbon black (including CNT), metal oxides such as ITO and the like, and low-resistance metals may be used.

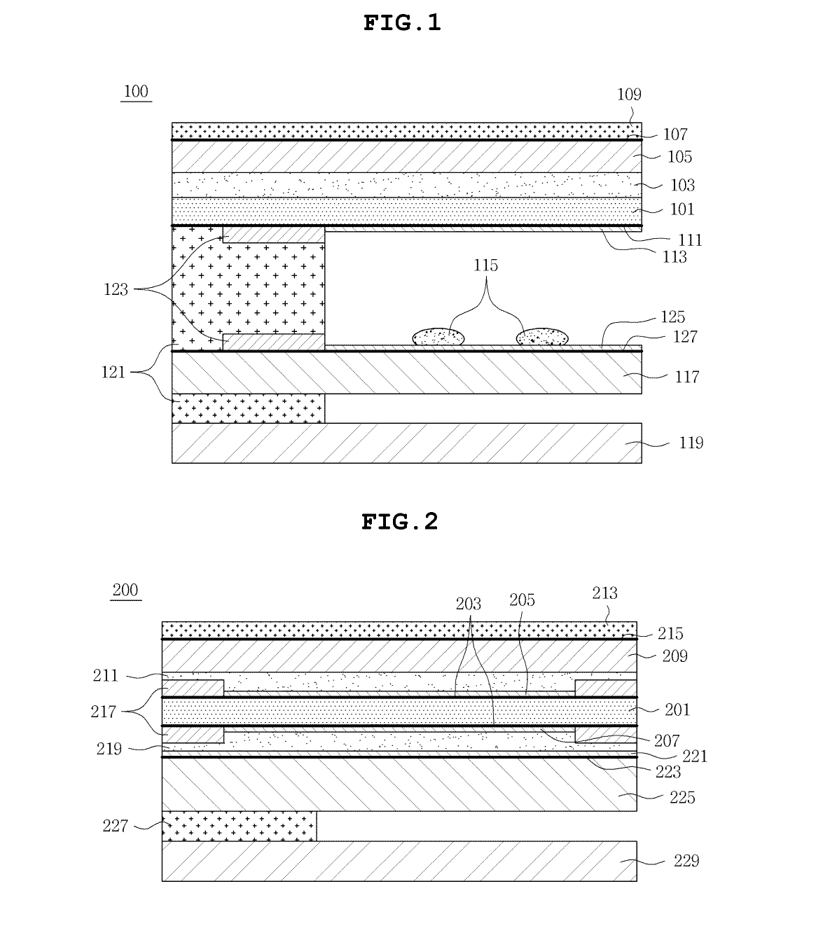

FIG. 1 is a schematic sectional view showing a resistive touch screen 100 according to the present invention, and FIG. 2 is a schematic sectional view showing a capacitive touch screen 200 according the present invention.

First, referring to FIG. 1, a primer layer 111 is formed on one side of a transparent film 101 to improve the adhesivity of the transparent film 101. A transparent electrode 113 is formed on the primer layer 111, and a transparent electrode 125 including dot spacers 115 formed thereon is disposed at the position spaced apart from the transparent electrode 113 by a predetermined distance according to the characteristics of a resistive touch screen. The transparent electrode 125, similarly to the transparent electrode 113, is formed on a primer layer 127 formed on a transparent substrate 117. The dot spacers 115 serve to reduce the impact occurring when the two transparent electrodes 113 and 125 come into contact with each other, serve to provide a repulsive force such that the transparent electrode 113 pressed by the transparent film 101 returns to its original position when the pressure applied to the transparent film 101 is removed, and serve as an insulation layer when it is not used. Therefore, the dot spacers 115 must have elasticity, and may be made of a transparent material such that images output from an image display unit are not blocked. However, the dot spacers 115 may be made of a hard material if the transparent electrodes 113 and 125 have durability and flexibility.

The transparent electrodes 113 and 125 are connected to silver (Ag) electrodes 123 for supplying voltage. In the resistive touch screen, the transparent electrodes 113 and 125 are connected to the silver (Ag) electrodes 123 using double-sided adhesive tape (DAT) such that the transparent electrodes 113 and 125 face each other.

Further, the transparent substrate 117 is attached to an image display unit 119 through double-sided adhesive tape (DAT) 121. Here, the image display unit 119 may be a liquid crystal display (LCD), a plasma display panel (PDP), an electroluminescence display (ELD), a cathode ray tube (CRT) or the like. Although not shown in drawings, in order to improve transparency by removing an air layer formed between the image display unit 119 and the transparent substrate 117, an optical clear adhesive (OCA) may be used.

Further, a cover sheet 105 is formed on the other side of the transparent film 101 in order to protect the transparent film 101. Here, the cover sheet 105 may be attached to the transparent film 102 through an optical clear adhesive (OCA) 103.

Further, a high-frequency or primer layer 107 may be formed on the cover sheet 105 in order to improve adhesivity, and a functional layer 109, such as a hard coating layer, an anti-fingerprint (AF) layer, an anti-glare (AG) layer or an anti-reflection (AR), may be formed on the primer layer 107. However, the cover sheet 105 is not necessarily required, and the functional layer 109 may be directly formed on the transparent film 101. Even in this case, the transparent film 101 may be high-frequency-treated or primer-treated in order to improve adhesivity.

Referring to FIG. 2, it can be seen that the capacitive touch screen 200, unlike the resistive touch screen 100, has no air layer.

First, high-frequency or primer layers 203 are formed on both sides of a transparent film 201, and transparent electrodes 205 and 207 are respectively formed on the high-frequency or primer layers 203. A cover sheet 209 may be formed on the transparent electrode 205, and the cover sheet 209 is attached to the transparent electrode 205 through an optical clear adhesive (OCA) 211. A functional layer 213, such as a hard coating layer, an anti-fingerprint (AF) layer, an anti-glare (AG) layer or an anti-reflection (AR), may be formed on the other side of the cover sheet 209. Even in this case, in order to improve the adhesivity between the cover sheet 209 and the functional layer 213, a high-frequency or primer layer 215 may be formed on the cover sheet 209. The capacitive touch screen 200, like the resistive touch screen 100, is provided with silver (Ag) electrodes 217 for supplying voltage to the transparent electrodes 205 and 207.

Further, the transparent electrode 207 may be attached to a transparent electrode 221 by an optical clear adhesive (OCA) 219, and the transparent electrode 221 is attached to a transparent substrate 225 including a high-frequency or primer layer 223 formed thereon.

The transparent substrate 225 is attached to an image display unit 229 using double-sided adhesive tape (DAT) 227.

As described above, the touch screen according to the present invention is advantageous in that a hard coating layer included in conventional touch screens was removed thereby improving its transmittance, and in that the number of total structural layers was decreased to strengthen its price competitiveness.

Further, the touch screen according to the present invention is advantageous in that a hard coating layer was removed which reduces the manufacturing process, and in that the thickness of a base film was increased allowing touch screens having a size of 22 inches or more to be manufactured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A touch screen, comprising:
a transparent film having a thickness of 188˜2000 μm; and
a transparent electrode layer formed on one side or both sides of the transparent film,
wherein one side or both sides of the transparent film is ultraviolet-treated, high-frequency-treated or primer-treated.

2. The touch screen according to claim 1, wherein the transparent electrode layer is formed by a printing process.

3. The touch screen according to claim 1, wherein the transparent electrode layer is made of poly-3,4-ethylenedioxythiophene/polystyrenesulfonate (PEDOT/PSS).

4. The touch screen according to claim 1, wherein the transparent electrode layer is made of a conductive polymer composition including a liquid crystal polymer and poly-3,4-ethylenedioxythiophene/polystyrenesulfonate (PEDOT/PSS).

5. The touch screen according to claim 1, wherein the transparent electrode layer is formed of a conductive adhesive prepared by mixing a transparent adhesive with one or more selected from a conductive polymer (for example, poly-3,4-ethylenedioxythiophene/polystyrenesulfonate, manufactured by Bayer Corp. or AGFA Corp., or polyaniline), carbon nanotubes, carbon black, graphene, metal or silver nanowires, copper (Cu), indium tin oxide (ITO) and antimony tin oxide (ATO).

6. The touch screen according to claim 4, wherein the liquid crystal polymer is an acrylic liquid crystal polymer.

7. The touch screen according to claim 4, wherein a conductive polymer film made of the conductive polymer composition has a surface resistance of 10˜1000 Ω/□.

8. The touch screen according to claim 4, wherein the liquid crystal polymer is 1,4-bis[3-(acryloyloxy)propyloxy]-2-methyl benzene.

9. The touch screen according to claim 1, wherein the transparent film includes one or more selected from a hard coating layer, an anti-fingerprint (AF) layer, an anti-glare (AG) layer and an anti-reflection (AR) layer formed on the outer surface thereof.

10. The touch screen according to claim 1, wherein the transparent film is made of polyethylene terephthalate (PET), polyethylene naphthalate (PEN), polyether sulfone (PES), glass, reinforced glass, polycarbonate (PC), cycloolefin copolymer (COC), polymethylmethacrylate (PMMA), triacetylcellulose (TAC), K-resin-containing biaxially-oriented polystyrene (BOPS), or a mixture thereof.

11. The touch screen according to claim 1, wherein the transparent film is any one selected from a polyethylene terephthalate (PET) film having a dielectric constant of 2.9˜3.5, a glass film having a dielectric constant of 7.5˜8.0, a silicon film having a dielectric constant of 2.5˜7.0, a urethane film having a dielectric constant of 6.5˜7.0, a polymethylmethacrylate (PMMA) film having a dielectric constant of 2.5˜4.5, and a polycarbonate (PC) film having a dielectric constant of 2.5˜3.5.

12. The touch screen according to claim 1, wherein the transparent film further includes a silver (Ag) electrode layer at an edge thereof.

13. The touch screen according to claim 12, wherein the silver (Ag) electrode layer is formed by a printing process.
